(19) United States
(12) Patent Application Publication
(10) Pub. No.: US 2013/0124555 A1
(43) Pub. Date: May 16, 2013

(54) NAVIGATING RELATED ITEMS IN DOCUMENTS BASED ON THEIR CLASSIFICATION, GROUPING, HIERARCHY OR ONTOLOGY

(71) Applicants: Joel Duquene, Raleigh, NC (US); Morris S. Johnson, Cary, NC (US); Henri F. Meli, Cary, NC (US); Jacques-Marie Thrasybule, Raleigh, NC (US)

(72) Inventors: Joel Duquene, Raleigh, NC (US); Morris S. Johnson, Cary, NC (US); Henri F. Meli, Cary, NC (US); Jacques-Marie Thrasybule, Raleigh, NC (US)

(73) Assignee: International Business Machines Corporation, Armonk, NY (US)

(21) Appl. No.: 13/296,962

(22) Filed: Nov. 15, 2011

(51) Int. Cl. G06F 17/30

(52) U.S. Cl. 707/769; 707/E17.014; 707/E17.008

(57) ABSTRACT

Disclosed are systems, methods and computer program products for navigating related items in responses to search requests. In response to a search request, a server determines a first results set of items, where the items have one or more item characteristics. The server receives a selection indicating one of the characteristics items in the first results set. The server performs a search utilizing the first characteristic to obtain a second set of items having the selected characteristic. A visual link indicator module of the server generates commands and data for displaying the second set of items having the selected characteristic. The display includes a visual indicator of a relationship of the second set of items to the selected characteristic.

### BACKGROUND

Embodiments of the inventive subject matter generally relate to the field of computer systems, and, more particularly, to navigating related items in documents based on classifications, groupings, hierarchies or ontologies relating items in the documents.

It is quite common for users to browse an on-line catalog and desire to navigate the catalog using different criteria. As an example, a user may be looking for a particular item such as a golf cart. The user may enter the term “cart” in a search field. The results of the search may include carts that are in different categories. For example, the results may include golf carts that the user may be interested in, but also may include carts that the user is not interested in such as office carts and printer carts. Further, a user may desire to select a particular item and then be able to navigate other items in the same category as that item. The other items may not have been in the initial search results. Additionally, a user may also desire to be able to quickly identify items that are in similar categories or made by the same manufacturer or having similar characteristics as items that are in a current list of search results. The related items may not be in the current list, but the user needs to be able to navigate to them.

It is also quite common for collection of books in a library to be catalogued, and indexed in an online catalog. For some book collections, such as wildlife catalogs, there may be many items of the same class and category. Those items that are of the same classification, hierarchy, groupings, etc. are often annotated such that it becomes easier to identify items of the same class, group or hierarchy. Oftentimes, when looking at a particular item in an online document, there is a need to navigate to similar items based on their ontology. For example, when looking at animals in a wildlife catalog containing many documents, one may need to browse the different categories of mammals or specific categories of mammals. And while looking at a particular animal (A feline, for example), the user may then want to browse the other animals of the same classification or other animals that belong to one of the subfamilies.

In either of the above examples, clicking on the link in a document causes the referenced section to come to view. However, the user can often lose track of where in the previous document the reference was selected that brought the new section into view.

### SUMMARY

Embodiments of the inventive subject matter include systems, methods and computer program products for navigating related items in responses to search requests. In response to a search request, a server determines a first results set of items, where the items have one or more item characteristics. The server receives a selection indicating one of the characteristics items in the first results set. The server performs a search utilizing the first characteristic to obtain a second set of items having the selected characteristic. A visual link indicator module of the server generates commands and data to display the second set of items having the selected characteristic. The commands and data include commands and data to display a visual indicator of a relationship of the second set of items to the selected characteristic.

### BRIEF DESCRIPTION OF THE DRAWINGS

The present embodiments may be better understood, and numerous objects, features, and advantages made apparent to those skilled in the art by referencing the accompanying drawings.

FIG. 1 depicts elements of a system for navigating documents according to embodiments.

FIG. 2 is a flowchart illustrating a method for navigating documents according to embodiments.

FIG. 3 is an example screen image of an initial search results screen.

FIG. 4 is an example screen image of a search results screen having visual links to related items.

FIG. 5 is an example screen image of a search results screen having visual highlighting of related items.

FIG. 6 is an example screen image of a search results screen having multiple windows with visual links between related items.

FIG. 7 is an example screen image of a search results screen with a visual link to a related subcategory screen.

FIG. 8 is an example computer system.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to a browser using in navigation, the systems and methods described herein may be readily applied to other document processing applications that incorporate navigation between items in documents. In other instances, well-known instruction instances, protocols, structures and techniques have not been shown in detail in order not to obfuscate the description.

In general, the systems and methods described below include a server that displays documents on client, for example, through a browser. An initial document includes the results of an initial search. Based on user selection of characteristics, subsequent searches may produce documents that contain subsets of items in the initial search, or new items. The server provides visual indicators that provide a visual cue to the user of how the items in the subsequent search are related to the selected characteristic. The visual indicators may be a line connecting a source characteristic to items having the characteristic, or the visual indicators may be highlighting. The visual indicators may be used as an aid to navigating documents.

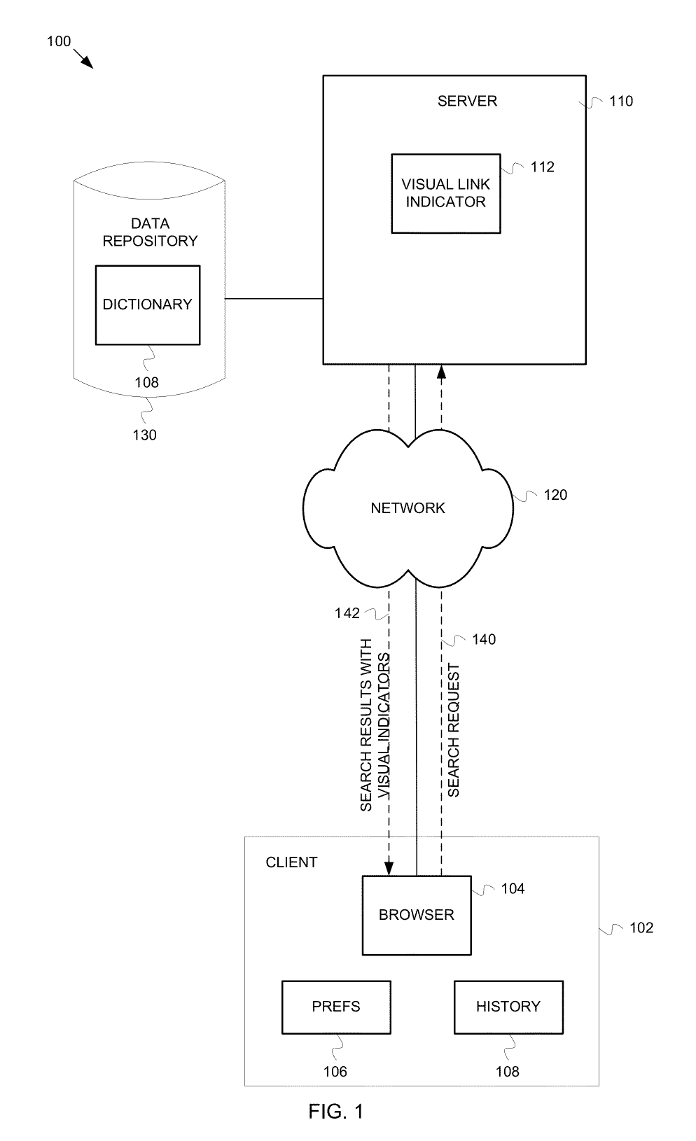

FIG. 1 depicts elements of a system 100 for navigating documents according to embodiments. In some embodiments, system 100 includes server 110, client 102 and data repository 130. Server 110 and client 102 may be communicably coupled to one another via network 120. Network 120 may be any type of communications network or collection of networks, including local area networks, wide area networks and the Internet.

Client 102 may be any type computing device capable of communicating with server 110. For example, client 102 may be a personal computer, tablet computer, laptop computer, mobile phone, personal digital assistant, music player or other such device. Client 102 includes a browser 104 for browsing documents received from server 110. In some embodiments, browser 104 may be configured as a web browser. Examples of such web browsers include Internet Explorer, Firefox, Safari, Chrome and other web browsers. In alternative embodiments, browser 104 may be a document browser for browsing particular types of documents such as image browsers, file browsers etc. The inventive subject matter is not limited to any particular type of browser.

Browser 102 issues search requests 140 to server 110. The search request includes one or more search parameters. In response to receiving a search request, server 110 searches data in repository 130 for items that satisfy the parameters of the search request. The items that match the parameters of the search request are provided as search results 142. Search results 142 may be provided as a document for display by browser 104 on client 102. As used herein, a document may be any of various types of documents, including web pages, images, text documents, audio data, video data and combinations thereof.

Data repository 130 stores data that may be searched in response to search requests. Data in repository 130 may be any type of data, including include text data, numeric data, image data, audio data, etc. Data repository 130 may be organized as a relational database, object database, file system, or combinations thereof. Although illustrated as one entity in FIG. 1, data repository 130 may be distributed across multiple systems.

In some embodiments, server 110 includes a visual link indicator 112. Visual link indicator 112 provides visual indications of relationships, categories, classifications, hierarchies, ontologies or groupings in response to search requests. For example, in response to a subsequent search request that is based on a characteristic of an item returned in a first request, visual link indicator 112 may provide a search results document that includes visual indications of items in the search results that are related according to the characteristic. For example, visual link indicator 112 may place lines in the search results document that connect related items to the characteristic, or may highlight in the search results document related items in a subsequent search result based on characteristics of items found in a first set of search results. Further, visual link indicator 112 may provide one or more windows that are displayed in addition to the original search results window where the additional window contains search results that have a desired characteristic.

In some embodiments, system 100 includes a dictionary 108. Dictionary 108 includes data that defines how characteristics are related or grouped. For example, in the case of a wildlife catalog stored in a repository, dictionary 108 may provide data indicating families of related animals and sub-families. The relationships or groupings in dictionary 108 may be used by visual link indicator 112 to indicate relationships in search results documents. Although illustrated as part of data repository 130, dictionary 108 may exist independently of data repository 130 in some embodiments.

In some embodiments, system 100 may include preferences 106. Preferences 106 stores user preferences regarding how relationships in search results are to be displayed to a user. For example, preferences 106 may store data indicating whether the user prefers that relationships be indicated by lines connecting related items to the search characteristic or whether the user prefers that related items in a search results document be highlighted.

In some embodiments, system 100 may include history data 108. History data 108 maintains a history of user selections. History 108 stores a history of the user's navigation (including in some embodiments, the sequence of navigation) and provides the user the ability to retrace the navigation steps after the user closes and later reopens the documents. The system may provide the ability to view a history of the link navigation and restore the navigation link history when the documents are opened (i.e., reload the navigation history upon opening of the documents). Using the navigation history, the system provides the ability to open a document and to remember the links that were navigated from a particular document, or to locations inside it.

Although shown as stored on client 102 in FIG. 1, either or both of preferences 106 or history 108 may be stored on other devices, including server 110.

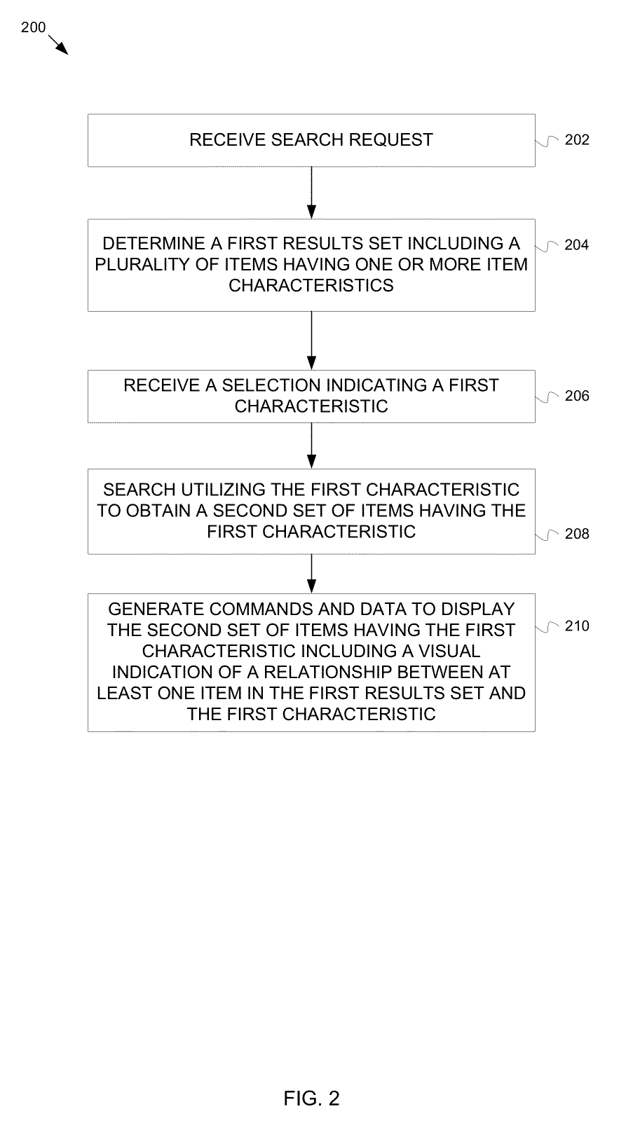

Further details on the operation of system 100 are provided below with reference to FIG. 2.

FIG. 2 is a flowchart illustrating a method 200 for navigating documents according to embodiments. Method 200 begins at block 202 by receiving a search request. The search request may specify one or more parameters that are used to determine items that are to be returned as results of the search. The items that are the object of the search request may include goods or services for sale, data regarding people, books, wildlife, or any other item that may have data describing the item stored in a data repository.

At block 204, server 110 searches one or more data repositories and returns a first results set that includes items in the repository that satisfy the search parameters. The items returned in the first results may have one or more characteristics associated with the items. Examples of such characteristics may include an item type, item color, item manufacturer, size, price, or any other characteristic that may be used to describe an item.

At block 206, server 110 receives a selection indicating a first characteristic of at least one of the items in the search results. The characteristic may be directly selected, for example, by selecting a name or identifier of the characteristic from a user interface element (menu, icon, drop-down box, etc.). Alternatively, the characteristic may be indirectly selected. For example, a user may select one of the items from the search results. In this case, the characteristics are inferred from the selection of the item and are thus indirectly selected.

At block 208, the selected characteristic or characteristics are then used to perform a subsequent search. The subsequent search produces a second results set that includes a second set of items having the characteristics directly or indirectly selected at block 206. The second set of items may be a subset of the first set of items, that is, the second set of items may be a subset of items in the first results set that share the selected characteristics. Alternatively, the second set of items may include new set of items (e.g., items that did not appear in the first results set) that have the selected characteristic or characteristics.

At block 210, the system generates commands and data to display a second set of items from the subsequent search for display to a user. The commands and data may be formatted according to a display command language such as a version of the HTML (Hypertext Markup Language). The results include one or more visual indicators that indicate a relationship between at least one item in the second results set and the selected characteristic. Various forms of visual indicators may be used. For example, in some embodiments, lines are displayed connected the items in the second results set to the first characteristic, providing a visual cue to the user of the characteristic and the items having the characteristic. In alternative embodiments, arrows or pointers may be used. In further alternative embodiments, the items in the second set of items may be highlighted to show which items share the selected characteristic or characteristics and which items do not share the selected characteristic or characteristics. Such highlighting may be based on color, flashing, brightness, etc. The form of visual indicator that is used may be determined by user preferences.

In some embodiments, a new window is opened to display the second results set. The new window may be positioned alongside or near the window displaying the first results set. The system may select a position and size for the new window based on the available on a display. A line or other visual indicator may link the source of the characteristic with the target document having the subsequent search results based on the source characteristic. Thus the user has a visual cue of the connection between the source location of the search characteristic and the target document.

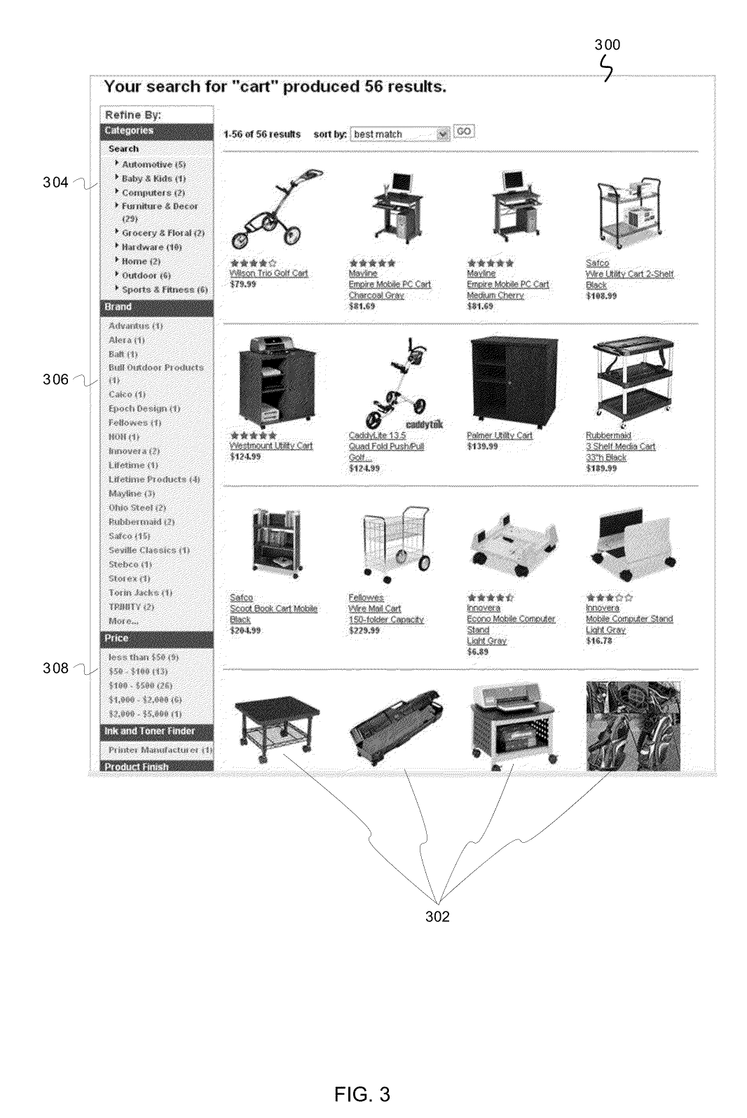

FIGS. 3-7 are example screen images that will be used as part of an example search session to further illustrate the operation of system 100 and method 200 described above and to provide description of further embodiments. For the purposes of the example, assume that repository 130 include items for sale by an online retailer. Further assume that a user of browser 104 is interested in purchasing a golf cart and issues a search request for carts to a server 110 configured as described above.

FIG. 3 is an example screen image 200 of an initial search results screen such as may be returned at block 204 above. Items 302 are items that are part of the initial search results for the search for “carts.” As can be seen in FIG. 3, various types of carts are returned in the search results, some of which may be of interest to the user, others of which are not. Screen image 200 includes menus 304, 306 and 308 that include various types of characteristics associated with items in the repository. As discussed above, various characteristics may be used to further refine the search. In the example illustrated in FIG. 3, such characteristics include categories 304, brands 306, and price 308.

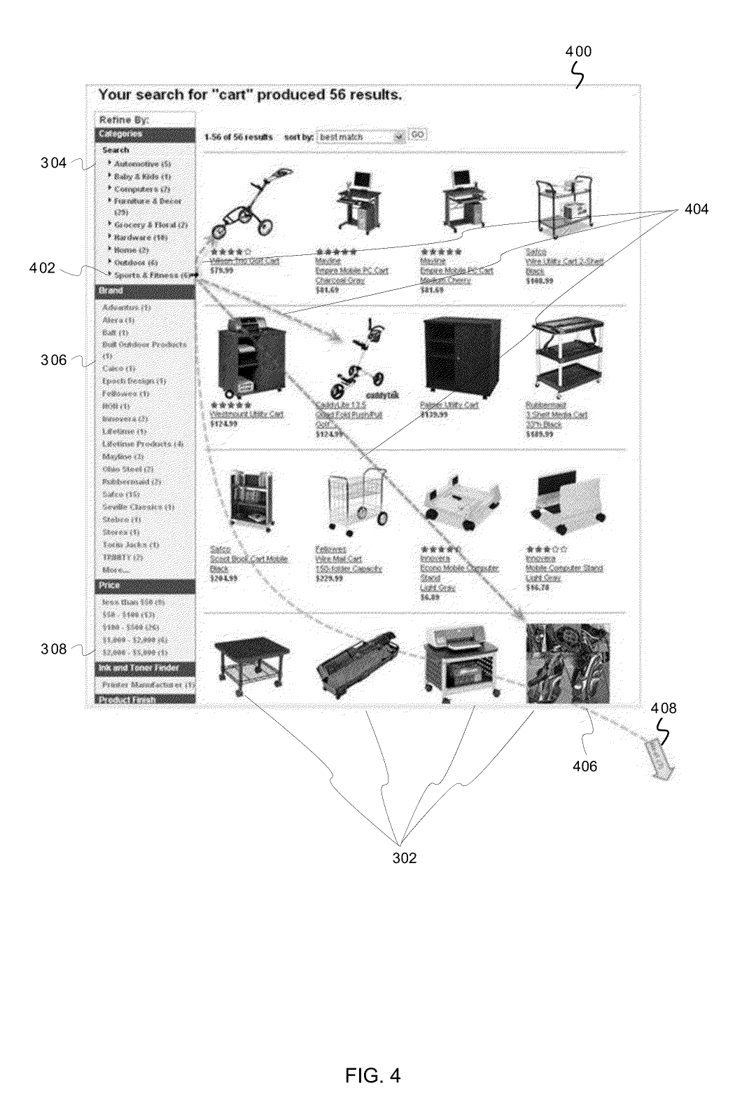

FIG. 4 is an example screen image 400 of a search results screen having visual indicators for items related to a first characteristic. In the example shown, a user has selected a category characteristic. In particular, the user has selected a label 402 associated with a “Sports and Fitness” category. In response, server 110 provides an update search results document for display as screen image 400 in which items that match the selected characteristic, the “Sports and Fitness” category, have a line 404 connecting the items that have the selected characteristic to the label 402 for the selected characteristic. Thus the user is given a clear indication of which items in the initial results set have the desired “Sport and Fitness” category.

It is possible that all of the items that share a selected characteristic do not fit on the display window. In some embodiments, server 110 draws a line 406 to a “next” navigation element 408 that indicates more items exist on a subsequent page or pages of results. In some embodiments, navigation element 408 may be an arrow that when selected, navigates to the next page of search results. Further, in some embodiments, navigation element 408 includes a count of the items on subsequent pages that share the selected characteristic.

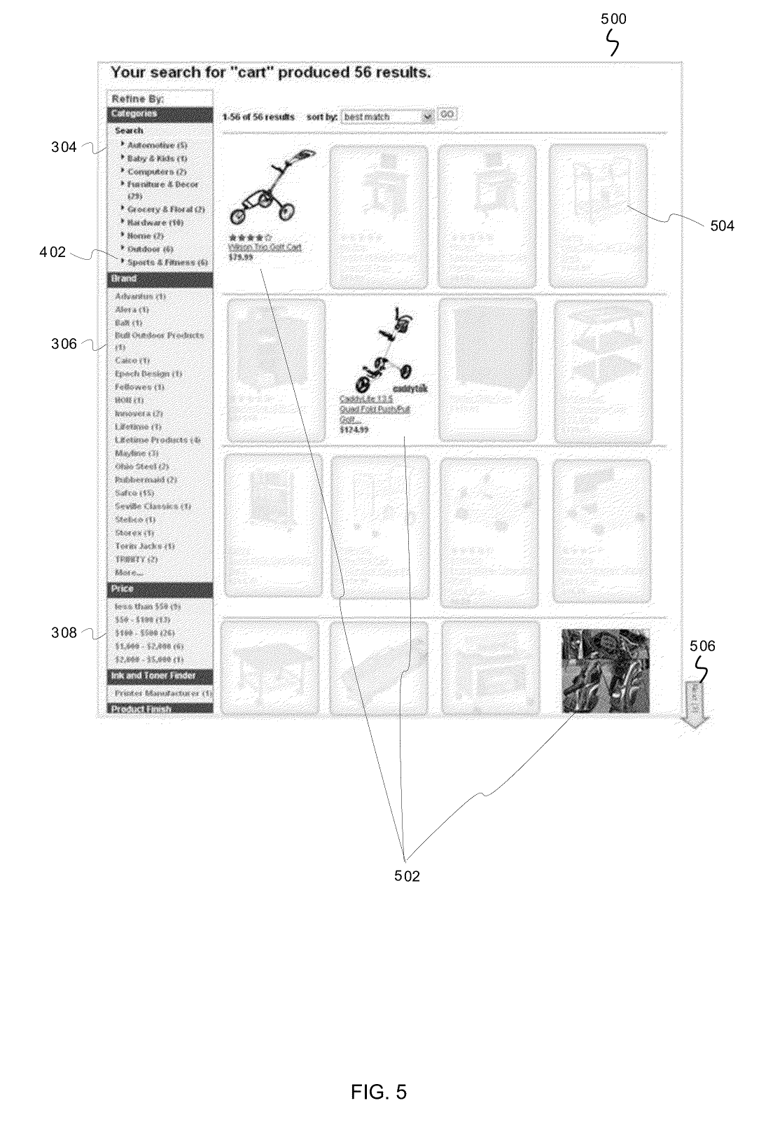

FIG. 5 is an example screen image 500 of a search results screen having visual highlighting of related items. As discussed above, highlighting is used in some embodiments to indicate items in a search results that have the selected characteristic. In the example screen image 500, the user has selected “Sports and Fitness” label 402 to determine the desired characteristic. In response, server 110 highlights items 502 in the search results set by dimming items that do not have the selected characteristic. As noted above, various highlighting mechanisms may be used in various embodiments. In addition, example screen 500 includes navigation element 506. Navigation element 506 indicates that more items having the selected characteristic exist on a next page or pages of the search results window. In some embodiments, navigation element 506 includes a count of items on the subsequent pages.

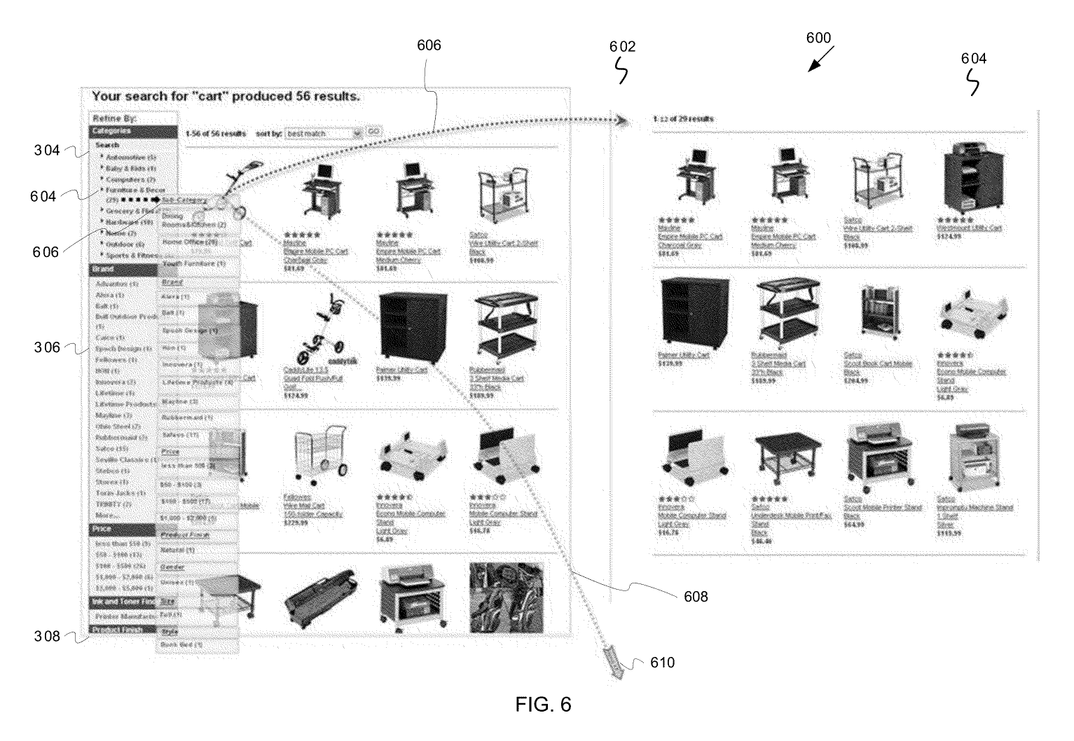

FIG. 6 is an example screen image 600 of a search results screen having multiple windows 602 and 604 with a visual link indicating the relationship between characteristic and items having the characteristic. In the example shown in FIG. 6, a search results window 602 includes an initial results set of items matching the search term “cart.” A user has selected label 604 associated with a “Furniture and Décor” category. In response, server 110 provided a subcategory menu having subcharacteristics of the “Furniture and Décor” category. In addition, server 110 has opened a new window 604 containing elements that have the “Furniture and Décor” characteristic. A line 606 indicates the relationship between the items in the new window 604 and the selected characteristic “Furniture and Décor.” As illustrated in example screen image 600, if more elements have the selected characteristic than can fit in a new window, server 110 provides a line 608 to a “next” navigation element 610 that indicates more items exist on subsequent pages of results. In some embodiments, selection of navigation element 610 causes the next page of items to appear in new window 604. In alternative embodiments, selection of “next” navigation element 608 cause a further new window to be displayed containing the next portion of the results set of the subsequent search. Navigation element 610 may include a count of the items remaining to be displayed.

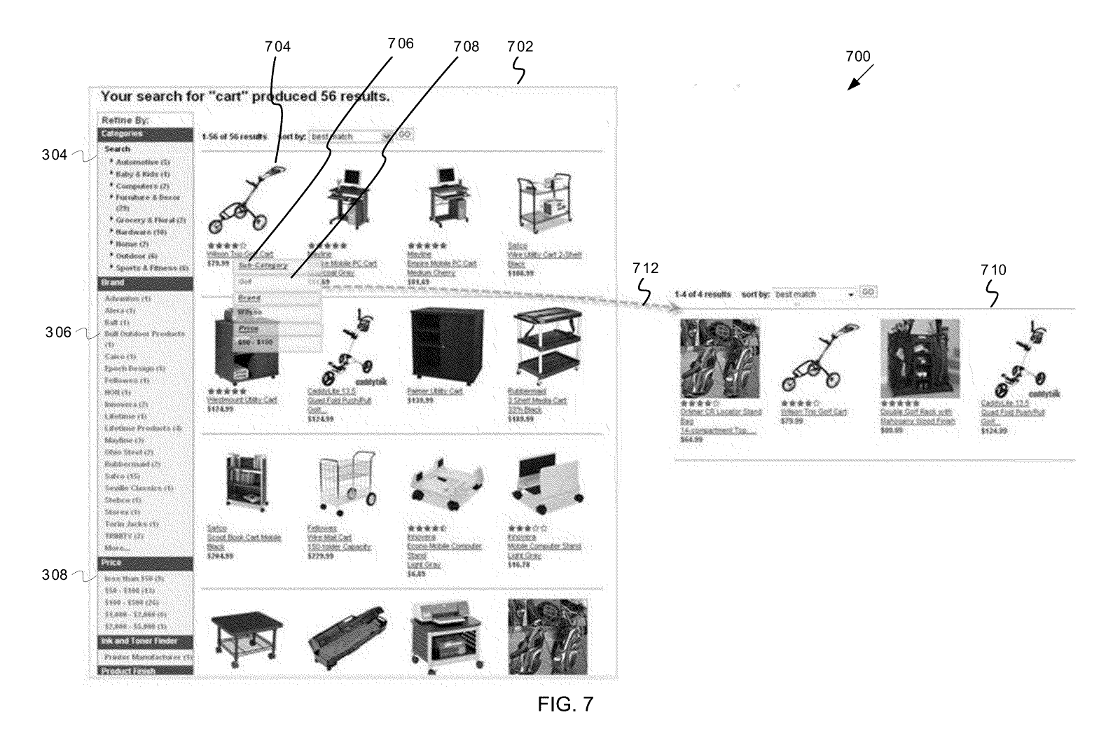

FIG. 7 is an example screen image 700 of a search results screen with a visual link to a related subcategory screen. In this example, the user has selected item 704. In response, server 110 cause a menu 706 to be displayed having specific characteristics for the selected item. Note that the characteristics displayed in menu 706 may include different characteristics than those used to produce the initial search results because the item may have additional characteristics. The user then selects the “Golf” label 708 from menu 706. In response, server 110 opens new window 710 that includes elements having the selected “Golf” characteristic. In addition, server 110 draws a line 712 from “Golf” label 708 to new window 710. The user thus has a visual cue that the new window contains items that have the desired “Golf” characteristic.

Although the examples above have been in the context of items for sale by online retailers, those of skill in the art having the benefit of the disclosure will appreciate that the systems and methods described above could be applied to other types of catalogs or data repositories. For example, a data represent collections of wildlife, books, or other items could be used.

The examples discussed above have provided a link from a characteristic in a source document to a target document of items found as the result of a subsequent search to have the characteristic. It should be noted that in some embodiments, a reverse link may also be provided. The reverse link locates in the target document the sections or portions of a target document that are referenced from the source document.

In addition to the features described above, various embodiments may also include a cache. The cache may be used to keep referenced documents active (cached) unless the next reference points to a different document. This avoids the closing and opening of the same document when navigating links that are either referenced from or referenced in the same document.

Upon closing a document, in some embodiments, focus goes back to the document from which the closed document was invoked.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

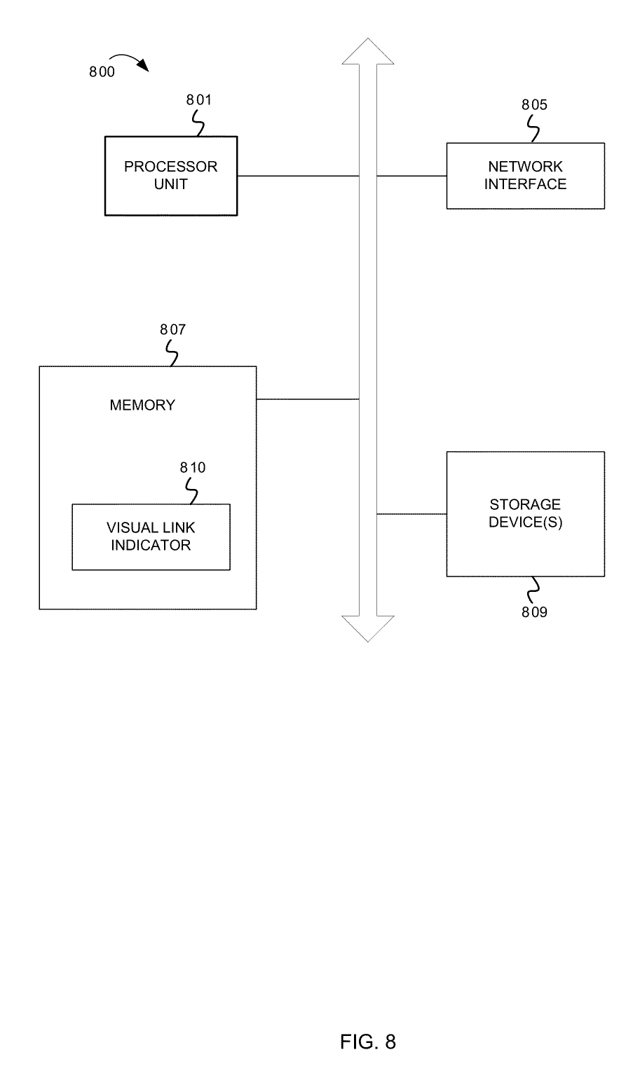

FIG. 8 depicts an example computer system. A computer system includes a processor unit 801 (possibly including multiple processors, multiple cores, multiple nodes, and/or implementing multi-threading, etc.). The computer system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 803 (e.g., PCI, ISA, PCI-Express, HyperTransport®, InfiniBand®, NuBus, etc.), a network interface 805 (e.g., an ATM interface, an Ethernet interface, a Frame Relay interface, SONET interface, wireless interface, etc.), and a storage device(s) 809 (e.g., optical storage, magnetic storage, etc.). The system memory 807 includes a document server 810 that includes functionality to implement embodiments described above. The system memory 807 may include some or all of the document server and visual link indicator functions described above. Alternatively, the functions of the document server 810 or visual link indicator described above may be distributed across multiple systems and system memories and may be loaded from one or more computer-readable media. Further, the data management system and query optimizer may be implemented with code embodied in co-processors, or on other hardware components such as cards, etc. Any one of these functionalities may be partially (or entirely) implemented in hardware and/or on the processing unit 801. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801, the storage device(s) 809, and the network interface 805 are coupled to the bus 803. Although illustrated as being coupled to the bus 803, the memory 807 may be coupled to the processor unit 801.

While the embodiments are described with reference to various implementations and exploitations, it will be understood that these embodiments are illustrative and that the scope of the inventive subject matter is not limited to them. In general, techniques for providing documents with visual link indicators as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
in response to a search request, determining a first results set including a plurality of items, the items having one or more item characteristics;
receiving a selection indicating a first characteristic of the one or more item characteristics;
upon receiving the selection, performing a search utilizing the first characteristic to obtain a second set of items having the first characteristic; and
generating commands and data for displaying the second set of items having the first characteristic, the commands and data including commands and data to display a visual indicator of a relationship of the second set of items to the first characteristic.

2. The method of claim 1, wherein the first results set is displayed as a first document, wherein receiving the selection indicating the first characteristic includes receiving a selection of a first link in the first document, and wherein generating commands and data for displaying the second set of items comprises generating commands and data for displaying the second set of items as a second document concurrently with the first document, and further comprising generating commands and data for displaying at least one visual indicator connecting the first link in the first document to an area in the second document.

3. The method of claim 2, and further comprising:
receiving a selection of a second link indicating a second characteristic;
generating commands and data for displaying at least one visual indicator connecting the second link in the first document to an area in the second document; and
tracking the selection of the first link and the second link in a selected link history.

4. The method of claim 2, and further comprising:
generating commands and data for displaying a reverse link identifying one or more references from the first document to the first reference in the second document.

5. The method of claim 2, and further comprising:
determining an area on a screen where there is enough space to display the second document.

6. The method of claim 1, wherein the second set of items comprises a subset of the first results set, and wherein generating commands and data for displaying the second set of items having the first characteristic includes generating commands and data for providing a visual indication of the second set of items in a same document as the first results set.

7. The method of claim 1, and further comprising:
upon reopening a document, loading a saved history of link selections; and
displaying the saved history of link selections.

8. A computer program product for navigating documents, the computer program product comprising:
a computer readable storage medium having computer usable program code embodied therewith, the computer usable program code comprising a computer usable program code configured to:
in response to a search request, determine a first results set including a plurality of items, the items having one or more item characteristics;
receive a selection indicating a first characteristic of the one or more item characteristics;
upon receipt of the selection, perform a search utilizing the first characteristic to obtain a second set of items having the first characteristic; and
generate commands and data for displaying the second set of items having the first characteristic, the commands and data including commands and data for displaying a visual indicator of a relationship of the second set of items to the first characteristic.

9. The computer program product of claim 8, wherein the first results set is displayed as a first document, wherein the computer usable program code configured to receive a selection indicating the first characteristic includes computer usable program code configured to receive a selection of a first link in the first document, and wherein the computer usable program code configured to generate commands and data for displaying the second set of items includes computer usable program code configured to generate commands and data to display the second set of items as a second document concurrently with the first document, and wherein the commands and data include commands and data for displaying at least one visual indicator connecting the first link in the first document to an area in the second document.

10. The computer program product of claim 9, wherein the computer usable program code is further configured to:
receive a selection of a second link indicating a second characteristic;
generate commands and data for displaying at least one visual indicator connecting the second link in the first document to an area in the second document; and
track the selection of the first link and the second link in a selected link history.

11. The computer program product of claim 9, wherein the computer usable program code is further configured to:
generate commands and data for displaying a reverse link identifying one or more references from the first document to the first reference in the second document.

12. The computer program product of claim 9, wherein the computer usable program code is further configured to:
determine an area on a screen where there is enough space to display the second document.

13. The computer program product of claim 8, wherein the second set of items comprises a subset of the first results set, and wherein the commands and data for displaying the second set of items having the first characteristic includes commands and data for providing a visual indication of the second set of items in a same document as the first results set.

14. The computer program product of claim 8, wherein the computer usable program code is further configured to:
upon reopening a document, load a saved history of link selections; and
display the saved history of link selections.

15. An apparatus comprising:
one or more processors; and
a visual link indicator module executable by the one or more processors and configured to:
in response to a search request, determine a first results set including a plurality of items, the items having one or more item characteristics,
receive a selection indicating a first characteristic of the one or more item characteristics,
upon receipt of the selection, perform a search utilizing the first characteristic to obtain a second set of items having the first characteristic, and
generate commands and data for displaying the second set of items having the first characteristic, the commands and data including commands and data for displaying a visual indicator of a relationship of the second set of items to the first characteristic.

16. The apparatus of claim 15, wherein the first results set is displayed as a first document, wherein the selection indicating a first characteristic comprises a selection of a first link in the first document, wherein the visual link indicator module generates commands and data including commands and data for displaying the second set of items as a second document concurrently with the first document, and wherein the at least one visual indicator connects the first link in the first document to an area in the second document.

17. The apparatus of claim 16, wherein the visual link indicator module is further configured to:
receive a selection of a second link indicating a second characteristic;
generate commands and data for displaying at least one visual indicator connecting the second link in the first document to an area in the second document; and
track the selection of the first link and the second link in a selected link history.

18. The apparatus of claim 16, wherein the visual link indicator module is further configured to:
generate commands and data for displaying a reverse link identifying one or more references from the first document to the first reference in the second document.

19. The apparatus of claim 16, wherein the visual link indicator module to:
determine an area on a screen where there is enough space to display the second document.

20. The apparatus of claim 15, wherein the second set of items comprises a subset of the first results set, and wherein the visual link indicator module is further configured to provide a visual indication of the second set of items in a same document as the first results set.
